(19) United States
(12) Patent Application Publication
(10) Pub. No.: US 2025/0342816 A1
(43) Pub. Date: Nov. 6, 2025

(54) Method, device and software to generate clear speech

(71) Applicants: Leonardo Wang, Walnut Creek, CA (US); Tianxin Wang, Walnut Creek, CA (US)

(72) Inventors: Leonardo Wang, Walnut Creek, CA (US); Tianxin Wang, Walnut Creek, CA (US)

(21) Appl. No.: 19/198,081

(22) Filed: May 4, 2025

Related U.S. Application Data
(60) Provisional application No. 63/642,834, filed on May 5, 2024.

(51) Int. Cl. G10L 13/033; G10L 13/047; G10L 15/06; G10L 15/07; G10L 15/08; G10L 15/30

(52) U.S. Cl. CPC G10L 13/033; G10L 13/047; G10L 15/063; G10L 15/07; G10L 15/08; G10L 15/30

(57) ABSTRACT

The current application discloses method, system, device and software for people with hearing loss or speech difficulty to generate clear and natural speech in their own voice, and to provide self-training for improving speech quality.

### CROSS-REFERENCE TO RELATED APPLICATIONS

This application claims benefit of and priority to U.S. Provisional Patent Application Ser. No. 63/642,834 filed on May 5, 2024, which is incorporated herein by reference in its entirety for all purposes. The entire disclosure of the prior application is considered to be part of the disclosure of the instant application and are hereby incorporated by reference.

### SUMMARY OF THE INVENTIONS

The current application discloses method, system, device and software for people with hearing loss or speech difficulty to generate clear and natural speech in their own voice, and to provide self-training for improving speech quality.

### BACKGROUND

There are 430 million people with disabling hearing loss around the world, 34 million of which are children. Cochlear implants are an effective treatment for deafness, however only 1 million people have access to it by 2022 due to high cost and other limitations.

People with hearing loss can use sign language, but the scope of its usage is limited given most people do not understand it. Sign language-to-speech apps also exist, though are not as easy to implement into daily use.

People with hearing loss can be trained to speak, but the training often requires special classes with speech therapists and is a long and costly process. It is challenging because they cannot hear their own voices to self-adjust during learning.

After training, people with hearing loss can speak out loud for communication using their own voice, which is most convenient and natural. However, their speech can often be difficult to discern and lack sufficient clarity for everyday use because they cannot hear their voice, which makes it very difficult to adjust and improve their speech to match the correct pronunciation due to lack of feedback. Self-conscious of this difficulty, they may be reluctant to speak and feel isolated.

### BRIEF DESCRIPTION OF THE DRAWINGS

FIG. 1 shows an example of building the speech recognition model and incorporating the model into a handheld device such as a cell phone.

FIG. 2 shows an example of using the device with the speech recognition model for daily communication.

FIG. 3 shows the stepwise screenshots of animation showing correct mouth shape and tongue position to pronounce “flower”.

FIG. 4 shows an example of sound visualization comparison to allow users to monitor and adjust their speech to pronounce “flower”.

### DETAILED DESCRIPTION

Now, with the help of speech-to-text apps, people with hearing loss can understand others' speech easily without a sign language interpreter. Being able to express themselves verbally with high quality (i.e. accuracy and clarity) speech will complete the circle and allow them to communicate with anyone freely, bringing much convenience to their daily lives, and would thus be highly valuable to them. The current invention discloses AI based approaches to achieve this.

The current invention discloses method and device using AI-powered software (e.g. an App) integrated with smartphones or wearable devices (e.g. smart glasses, smart watch, smart necklace/ring, brooch/pin) to convert unclear pronunciations/speech to synthetic clear pronunciations/speech. The current invention discloses AI-powered software (e.g. an App) which can be integrated with smartphones or wearable devices to convert unclear pronunciations/speech to synthetic clear pronunciations/speech.

In the current invention speech reconstruction is used to reconstruct the unclear speech of people with hearing loss or patients having speech disorders (e.g. those with dysarthria or throat/vocal cord disorder/surgery) into clear speech.

The method comprises collecting user audio input or lip reading which could be difficult to understand, generating spoken audio translation that is clearer and more easily understandable with a speech recognition software, optionally mimicking user's own accent/voice characteristics, and optionally providing review and precise guidance to the user on how to improve their speech quality with accurate pronunciation using a self-training tool such as a software.

The current invention also discloses a system comprising said AI powered software and said device to convert unclear pronunciations to synthetic clear pronunciations, and optionally providing review and precise guidance to the user on how to improve their speech quality with accurate pronunciation using a self-training tool. In some embodiments the system further comprises a remote AI service such as a cloud computing AI service to generate a speech recognition model for the user.

The system comprises a device which can be a smartphone or wearable device embedded AI-powered App. The system and smartphone/wearable device collect user audio input or lip reading, translates them into text with the embedded AI-powered App, and generates spoken audio based on the text. The system and the device comprise a microphone, a speaker and an AI-powered App having a speech/voice recognition module and a text to speech module.

The system/device collects user audio input or lip reading which could be difficult to understand, generates spoken audio translation that is clearer and more easily understandable, mimicking the user's own accent/voice characteristics. It optionally provides review and precise guidance to the user on how to improve their speech quality with accurate pronunciation as a self-training tool.

The method/system for people with hearing loss is based on a software approach that can be integrated within a smartphone, or a wearable device (e.g. smart watch, smart glass, or a dedicated device) for greater convenience (hands-free).

In some embodiments the AI app has a speech generation agent. In some embodiments the AI app comprises two agents: a speech generation agent and a self-training agent.

In some embodiments, the speech generation agent uses machine learning such as supervised machine learning to train AI with speech recognition ability, using potentially inaccurate speech patterns from the user as datasets. People with born hearing loss or speech disorder often have their own unique pronunciation patterns/tunes which do not follow the standard rules of people without those issues. The AI model can be trained to recognize them. Each user's speech can be used to build their own speech recognition model. For example, a user can read selected text such as paragraphs or sentences, dictionary sections or a book so the speech generation agent can train/build a speech recognition model using the voice/speech and the matching text. In some embodiments, the speech generation agent uses supervised machine learning to train AI with image recognition ability for lip reading recognition, similarly using potentially inaccurate lip patterns as dataset for the user. Each user's speech can be used to build their own lip reading recognition model. For example, a user can read selected text so the speech generation agent can train/build a lip reading recognition model using the lip reading and the matching text.

The resulting personalized speech recognition model or lip reading recognition model or their combinations is used to generate the text for the user when they speak. And a text-to-speech engine in the speech generation agent produces accurate pronunciations using the text generated, optionally using the sound characteristics generated from voice analysis for that user. The user's sound characteristics can be analyzed during training and used to synthesize sound to mimic their voice to produce “true voice” speaking for the specific user in their own sound characteristic.

In some embodiments to perform training, the user reads training text and the speech generation agent uploads the audio data and matching text to a cloud based AI to build a customized speech recognition model for this user. The resulting model is downloaded to the agent's speech recognition module which is part of the software/app residing in the cell phone or wearable device for daily use.

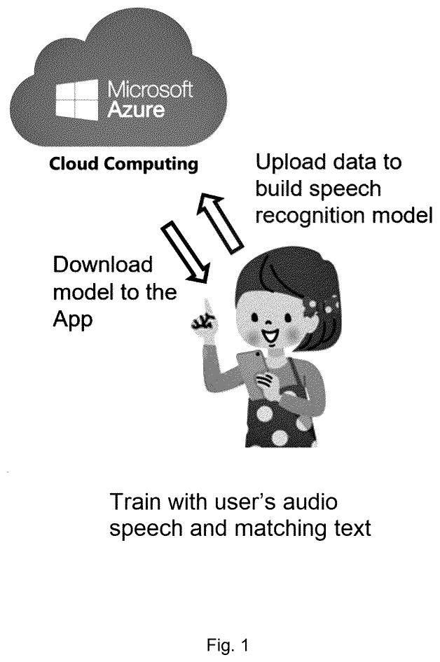

FIG. 1 shows an example of building the speech recognition model and incorporating the model into a handheld device such as a cell phone. The agent displays the text in the cell phone screen and asks the user to speak out the text. The user generated speech voice is recorded, the sound data and matching text is sent to the cloud computing AI service or a remote AI service server/center for training to generate a customized speech recognition model. Alternatively the cloud sends the text to the agent for the user to read and only the user's voice needs to be uploaded to the cloud as the cloud already knows the matching text. After sufficient data is provided for training, the model is generated and downloaded to the agent in the cell phone, which will be used for daily conversation. In some embodiments, the agent itself has an AI module to build the speech recognition model therefore the user's voice and matching text do not need to be uploaded to the cloud or remote server. The training of the model can be done by the agent alone in the cell phone alone therefore no need to download the model from cloud/remote server.

During conversation, the user speaks with their mouth in their own voice, the smartphone or wearable device's microphone picks up the voice to be processed by the agent, the agent uses the trained model to recognize the user's speech content (text), and say it out loud from the speaker of the smartphone or wearable device using the built-in text-to-speech module, to produce a more easily understandable speech for the conversation. It can optionally display the text in the smartphone or wearable device, which allows the user to check the accuracy of the content produced and also can be shared with the other party of the conversation.

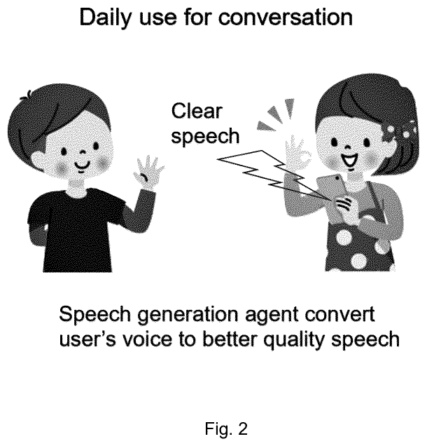

FIG. 2 shows an example of using the device with the trained speech recognition model and the speech generation agent for daily communication. The speech generation agent in the user's cell phone uses the personalized speech recognition model to recognize the content of the user's speech during conversation. The content text is converted to speech by the text to speech module of the agent and speaks out high quality synthesized voice by the cell phone to other people in the conversation.

In some embodiments to perform training, the user reads training text and the speech generation agent uploads the lip shape/movement data and matching text to a cloud based AI to build a customized lip reading recognition model for this user. The resulting model is downloaded to the agent's speech recognition module which is part of the agent app residing in the cell phone or wearable device for daily use.

Alternatively in some embodiments, training speech recognition model can be done separately from/outside the speech generation agent. The speech generation agent does not perform speech recognition model generation. Collecting the user's speech for training and building the speech recognition model is performed by other software/agent residing in another place such as a computer or a web server. For example, the user can use a computer to access a web based service to upload their speech and matching text to build the personalized speech recognition model. Alternatively, a computer such as a PC is used to collect the user's speech for training and building the speech recognition model using an AI agent built within. The resulting speech recognition model is transferred/downloaded to the speech generation agent in the cell phone/wearable device. The speech generation agent uses the model and a text-to-speech engine to convert user's unclear speech to clear speech.

During conversation, the user speaks with their mouth, the agent uses the trained model to recognize the user's speech content (text), and say it out loud from the speaker of the smartphone or wearable device using the built-in text-to-speech module, to produce a more easily understandable speech for the conversation. It can optionally display the text in the smartphone or wearable device, which allows the user to check the accuracy of the content produced and also can be shared with the other party of the conversation. Therefore, the agent can also use lip reading for training (image recognition) to build the model and use the model in conversation for daily use, which allows the user to mouth words silently. It can also increase content accuracy when used together with voice based speech recognition.

In some embodiments, a context prediction/checking module can be incorporated within the agent to improve content accuracy. Besides using the user's voice or lip reading or their combinations to generate the speech content, the built in context prediction/checking module can also use the context during the conversation to predict and adjust the speech content to generate more accurate content.

The agent can also analyze the user's sound characteristics and use it to synthesize sound to mimic user/s own voice (e.g. pitch, tune, speed etc.) to allow the user's “true voice” to be used in speaking the content by the speaker during conversation.

The microphone and speaker can be integrated in one device such as a cell phone. Alternatively, they can be in separate devices. For example, the microphone can be a Bluetooth microphone attached to the user's collar to collect the voice of the user and transmit it to the user's cellphone to perform speech content recognition. A separate Bluetooth speaker in the form of a badge receives the synthesized speech data from the cellphone and speaks it out loud. This will allow the user to be hand free during the conversation. The speaker and microphone can also be integrated in one wearable device.

The AI app/software can also comprise a self-training agent. It reviews the user's speech, provides training to improve speech on mispronounced words. It can use image/animation/instruction showing correct mouth shape/movement and tongue position/movement for training. It can use sound visualization comparison to allow the user to monitor speech adjustments in real time.

In some embodiments, the self-training agent comprises an image recognition module such as a image recognition AI and use it to compare user's mouth/tongue shape/movement with a standard library (e.g. a library of 500 common syllables for English) to advise user how to adjust mouth/tongue/air flow to the correct shape/movement to speak the target content. For example, the agent displays the instructions on the cell phone screen in the form of text or figure or animation/video.

In some embodiments, the self-training agent comprises a general speech-to-text module (a standard speech-to-text AI used to recognize speech from people without speech issue, not the one trained for the user) and use it to evaluate the pronunciation accuracy of the user with hearing loss or speech disorder, for reviewing and similarity linking. The general speech-to-text module converts the user's speech to text and compares this text with the text generated using the user specific speech-to-text module (the AI model trained with the user's voice). The higher the agreement between the content of the two sets of text, the better the speech quality the user produces with his voice, the self-training agent will give a higher score and the user will be able to know whether the voice in his speech is accurate and can use the score to adjust accordingly. It can also provide speech similarity linking. Similarity linking means if the user intends to speak content A (e.g. word A) but the general speech-to-text module shows content B, the user will know that the current way he speaks content A can be used to speak content B instead. Then he can use the mouth/tongue shape/movement and airflow pattern he used to speak content A to speak content B.

Using similarity linking, the agent will tell the user if the pronunciation for the target syllable/word matches another one better and if the pronunciation for another matches the target syllable/word, to help the user to trace and follow the correct pronunciation.

The self-training agent can be used to improve the user's own speech quality. The user's speech in the conversation is stored and will be scored/reviewed afterward by the agent. Precise guidance/training on how to improve their pronunciation accuracy will be provided by the agent.

The self-training agent can use image/animation/video to show the correct mouth shape, tongue position, airflow for low score syllables/words, and provide instructions on what/how to adjust.

The self-training agent uses sound visualization comparison between target sound spectrum profile and current profile to guide the user to adjust their voice to produce desired sound, which can generate real time feedback during self-training. This approach utilizes visual feedback to learn to speak instead of audio feedback used by people without hearing issues.

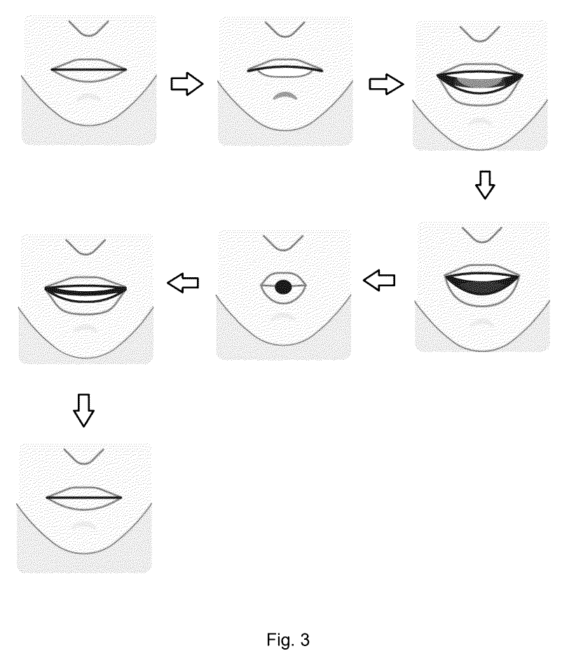

FIG. 3 shows the stepwise screenshots of animation showing correct mouth shape and tongue position to pronounce “flower”. The self-training agent shows the animation in the cell phone display to teach the user how to correctly pronounce the word “flower” by telling him this is the correct mouth shape and tongue position to say “flower”.

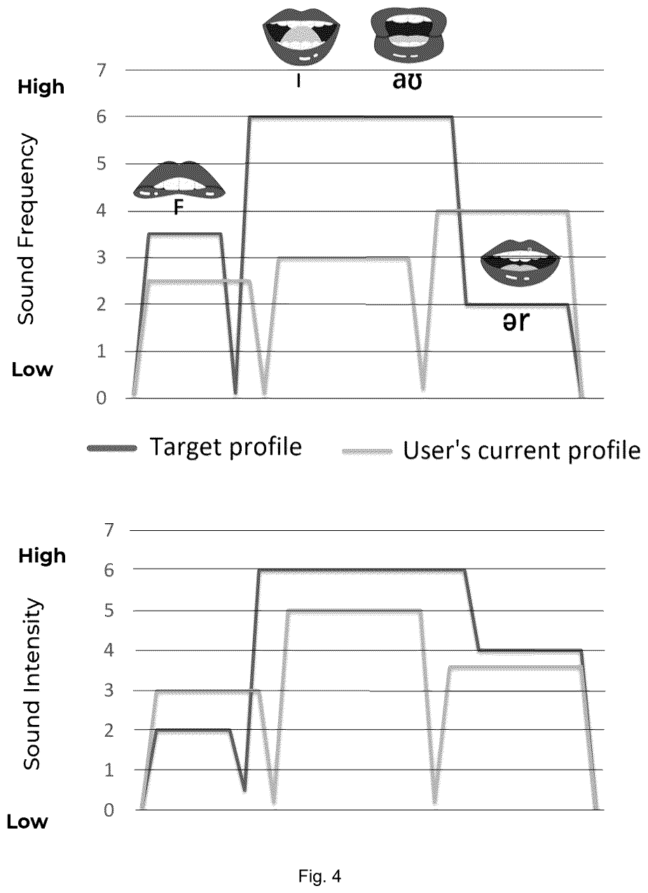

FIG. 4 shows an example of sound visualization comparison to allow users to monitor and adjust their speech to pronounce “flower”. The sound visualization plot or animation produced by the agent is displayed on the cell phone screen to show the user what they can improve and adjust. The target profile shows the correct sound intensity/frequency/length of the syllables when the user wants to say “flower” and the correct mouth/tongue shape. The user's current profile shows sound intensity/frequency/length for what he produces for “flower”. The user can adjust his speech pattern accordingly to improve his speech by trying to alight the two profile curves closer/overlap. The plot can be dynamic in real time. It can also show the overlay with the previous plot and the trend. This will help the user know which direction he needs to adjust by seeing the effect of changing his speech pattern historically and in real time. Normal people learn to speak correctly based on the feedback from hearing his voice. The agent uses sound visualization as feedback instead to allow the user to learn to speak correctly. Other sound visualization plots/techniques can also be used such as time resolved sound spectrum.

Alternatively, the self-training agent and speech recognition agent can be separate software/apps. They can also be in different hardware. For example, the speech recognition agent is in one cell phone, the self-training agent is in another cell phone or PC. The self-training agent or speech recognition agent or both can also be purely cloud based instead of residing in the user's cell phone or wearable device. The user can use his cell phone or wearable device or PC to upload data such as their speech and download the result such as the generated clear speech.

In some embodiments, daily use data and training results will be stored and uploaded periodically such as weekly or monthly to update the personalized speech recognition model.

In summary, the current invention discloses a method to help the people with speech difficulty by converting unclear pronunciations/speech to synthetic clear pronunciations/speech in real time during conversation and provide training on how to improve speech quality. The method comprises collecting user's audio input which could be difficult to understand and/or lip reading, and matching text; building a personalized speech recognition model; using the model to recognize the content of the user's speech during conversation; and generating spoken audio translation based on the content generated, optionally mimicking user's own accent/voice characteristics. Optionally the method further comprises providing review of their speech and precise guidance to the user on how to improve their speech quality with accurate pronunciation using a self-training tool.

In another word, the method for converting unclear pronunciations to clear pronunciations during conversation for a subject (user) in need comprises collecting user's speech and matching text to build a personalized speech recognition model; using the model to recognize the content of the user's speech during conversation; and generating clear synthetic audio speech based on the content generated; and optionally display the content visually. Optionally the synthetic audio speech mimics user's own sound characteristics and is produced with a text to speech engine.

The current invention also discloses a software to convert unclear pronunciations/speech to synthetic clear pronunciations/speech. The software comprises a speech generation agent which can use a built-in personalized AI powdered speech recognition model customized for the user to convert the user's unclear speech to text, and use a built-in text to speech engine to convert the text to a synthetic speech during conversation. The speech generation agent can further comprise a speech recognition model generating module to build the personalized speech recognition model. The software can further comprise a self-training agent, which reviews the user's speech, provides training to improve speech on producing correct pronunciation.

In another word, the software for converting unclear pronunciations to clear pronunciations during conversation for a subject (user) in need comprises a speech generation agent which uses a built-in personalized AI powdered speech recognition model customized for the user to convert the user's unclear speech to text, wherein the speech generation agent further converts said text to speech using a built-in text to speech engine. The speech generation agent further comprises a speech recognition model generating module to build the personalized speech recognition model. The software optionally comprises a self-training agent that reviews the user's speech, provides training to improve speech on producing correct pronunciation.

The current invention also discloses a portable device such as a cellphone or wearable device to convert user's unclear pronunciations/speech to synthetic clear pronunciations/speech. The device comprises one or more microphones, one or more speakers and said software comprising a speech generation agent built within. The device uses said microphone to collect the user's speech sound and speak out the synthetic speech generated by the speech generation agent during conversation. The device can comprise said self-training agent built within.

The current invention also discloses a system to convert unclear pronunciations/speech to synthetic clear pronunciations/speech. The system comprises a device which can be a smartphone or wearable device embedded AI-powered App. The system uses the smartphone/wearable device and the embedded AI-powered App to collect user audio input or lip reading, translates them into text with the embedded AI-powered App, and generates spoken audio based on the text. The system comprises a microphone, a speaker and the AI-powered App having a speech/voice recognition module using a built in personalized speech recognition model and a text to speech module. The microphone and speaker can be integrated within said device or separated from said device. The system further comprises a cloud AI service/remote AI service for speech recognition model training.

This AI concept is reliable and safe. It relies on well-developed/mature technology. Speech-to-text app for people without hearing loss and lip reading app for people with throat issues are successful and reliable. Users can check the generated text display for accuracy. Privacy and personal data can be secured and safeguarded to the highest standard, which will be controlled by the user and is not visible to other people. Other people's speech will be deleted after the conversation. This AI concept is transparent. The data flow is controlled by the user and clear instruction/status on each step will be displayed for the user to monitor. The user has full control on the use of the AI and can turn it off anytime. It can inform the user each step with a text display and the user can interfere/take control anytime. The user is ultimately accountable for the use of the AI. As a non-generative AI, its activity is ultimately controlled by the user and developer. The app can be frequently updated and vulnerabilities in models will be addressed when discovered. Updates will be made accessible from the internet. The app accesses the internet when uploading data for cloud-based AI training or installing updates. Users will be able to store trained models on their devices themselves. The speech generation agent can work offline without the internet.

While the app uploads voice audio from users to cloud databases, secure passwords and two-factor-identification can be used to make sure each user can only view their own data and no other people can see the data. The data transmission will be encrypted to protect security. Accounts and information stored in cloud databases can only include what is necessary for the app to function and not contain personal identifying information past users' voices, so even in the case of a security breach system infiltrators will not be able to match voices to the people they belong to. Users will be notified upfront and during use about what data is collected, where it is sent, and how it is used.

This approach will help many of the 430 million people with hearing loss, improve their communication via natural speech to a level of accuracy and fluency close to that of the general population. It will increase the speed, accuracy, and convenience of communication for people with hearing loss. Many people with hearing loss do not have access to speech training due to high cost and no access to special training classes. The current invention can provide self-training opportunities to the majority of them, allowing them to learn to speak any time, any place at a very low cost.

The current invention, by improving communication via natural speech, will encourage and empower hearing impaired people to interact with the general population, thus reducing social isolation and increasing integration into the general population in social activities. This will help them increase personal satisfaction, improve productivity, have more job opportunities and enjoy life better.

In the current application, the “/” mark means either “and” or “or”. Unless otherwise defined, all technical and scientific terms used herein have the same meaning as commonly understood by one of ordinary skill in the art to which this invention belongs. All patents and publications mentioned in this specification are indicative of the level of those skilled in the art to which the invention pertains, and herein incorporated by reference to the same extent as if each individual publication was specifically and individually indicated to be incorporated by reference. The inventions described above involve many well-known principles, instruments, methods and skills. A skilled person can easily find the knowledge from textbooks, scientific journal papers and other well-known reference sources.

1. A method for converting unclear pronunciations to clear pronunciations during conversation for a subject in need thereof, the method comprising:
collecting user's speech and matching text to build a personalized speech recognition model;
using the model to recognize the content of the user's speech during conversation; and
generating clear synthetic audio speech based on the content generated.

2. The method of claim 1, wherein said synthetic audio speech mimics user's own sound characteristics.

3. The method of claim 1, wherein said synthetic audio speech is produced with a text to speech engine.

4. The method of claim 1, further display the content visually.

5. A software for converting unclear pronunciations to clear pronunciations during conversation for a subject in need thereof, said software method comprising a speech generation agent which uses a built-in personalized AI powdered speech recognition model customized for the user to convert the user's unclear speech to text.

6. The software of claim 5, wherein the speech generation agent further converts said text to speech using a built-in text to speech engine.

7. The software of claim 5, wherein the speech generation agent further comprises a speech recognition model generating module to build the personalized speech recognition model.

8. The software of claim 5, further comprising a self-training agent that reviews the user's speech, provides training to improve speech on producing correct pronunciation.
